(19) United States
(12) Patent Application Publication
(10) Pub. No.: US 2007/0089416 A1
(43) Pub. Date: Apr. 26, 2007

(54) Combustion engine including engine valve actuation system

(76) Inventors: James R. Weber, Lacon, IL (US); Scott A. Leman, Eureka, IL (US); Gerald N. Coleman, Bulwick (GB); Kevin P. Duffy, Metamora, IL (US); Eric C. Fluga, Dunlap, IL (US); Jonathan P. Kilkenny, Peoria, IL (US); Sean O. Cornell, Gridley, IL (US)

Correspondence Address: Finnegan, Henderson, Farabow,;Garrett & Dunner, L.L.P., 901 New York Avenue, N.W., Washington, DC, 20005-3315, US

(21) Appl. No.: 11/520,029

(22) Filed: Sep. 13, 2006

Related U.S. Application Data
(63) Continuation of application No. 10/992,071, filed on Nov. 19, 2004, now abandoned.
Application No. 10/992,071 is a continuation-in-part of application No. 10/933,300, filed on Sep. 3, 2004, now Pat. No. 7,178,492.
Application No. 10/933,300 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,071 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,071 is a continuation-in-part of application No. 10/309,312, filed on Dec. 4, 2002.
Application No. 10/309,312 is a continuation-in-part of application No. 10/283,373, filed on Oct. 30, 2002, now Pat. No. 7,004,122.
Application No. 10/283,373 is a continuation-in-part of application No. 10/144,062, filed on May 14, 2002, now Pat. No. 7,069,887.

(51) Int. Cl. F02B 33/44; F02B 29/04; F02B 47/08; F02M 25/07; F02B 3/00; F02B 75/02

(52) U.S. Cl. 60/605.2; 123/316; 123/299; 123/563; 123/568.11; 60/599; 60/612

(57) ABSTRACT

Engines and methods of controlling an engine may involve at least one fluid actuators associated with one or more engine intake and/or exhaust valves. Timing of valve closing/opening and use of an air supply system may enable engine operation according to a Miller cycle.

### RELATED APPLICATIONS

This application is a continuation-in-part of U.S. patent application Ser. No. 10/933,300, filed Sep. 3, 2004, which is a continuation-in-part of U.S. patent application No. 10/733,570, filed Dec. 12, 2003, which is a continuation of U.S. patent application Ser. No. 10/143,908, filed May 14, 2002, now U.S. Pat. No. 6,688,280. This application is also a continuation-in-part of U.S. patent application Ser. No. 10/733,570, filed Dec. 12, 2003, which is a continuation of U.S. patent application Ser. No. 10/143,908, filed May 14, 2002. This application is also a continuation-in-part of a U.S. patent application Ser. No. 10/309,312, filed Dec. 4, 2002, which is a continuation-in-part of U.S. patent application Ser. No. 10/283,373, filed Oct. 30, 2002, which is a continuation-in-part of U.S. patent application Ser. No. 10/144,062, filed May 14, 2002.

The entire disclosure of each of the U.S. patent applications mentioned in the preceding paragraph is incorporated herein by reference. In addition, the entire disclosure of each of U.S. Pat. No. 6,688,280 and U.S. Pat. No. 6,651,618 is incorporated herein by reference.

### TECHNICAL FIELD

The present invention relates to a combustion engine, an air and fuel supply system for use with an internal combustion engine, a variable engine valve actuation system.

### BACKGROUND

An internal combustion engine may include one or more turbochargers for compressing a fluid, which is supplied to one or more combustion chambers within corresponding combustion cylinders. Each turbocharger typically includes a turbine driven by exhaust gases of the engine and a compressor driven by the turbine. The compressor receives the fluid to be compressed and supplies the compressed fluid to the combustion chambers. The fluid compressed by the compressor may be in the form of combustion air or an air/fuel mixture.

An internal combustion engine may also include a supercharger arranged in series with a turbocharger compressor of an engine. U.S. Pat. No. 6,273,076 (Beck et al., issued Aug. 14, 2001) discloses a supercharger having a turbine that drives a compressor to increase the pressure of air flowing to a turbocharger compressor of an engine.

While a turbocharger may utilize some energy from the engine exhaust, the series supercharger/turbocharger arrangement does not utilize energy from the turbocharger exhaust. Furthermore, the supercharger requires an additional energy source.

The operation of an internal combustion engine, such as, for example, a diesel, gasoline, or natural gas engine, may cause the generation of undesirable emissions. These emissions, which may include particulates and nitrous oxide (NOₓ), are generated when fuel is combusted in a combustion chamber of the engine. An exhaust stroke of an engine piston forces exhaust gas, which may include these emissions from the engine. If no emission reduction measures are in place, these undesirable emissions will eventually be exhausted to the environment.

Research is currently being directed towards decreasing the amount of undesirable emissions that are exhausted to the environment during the operation of an engine. It is expected that improved engine design and improved control over engine operation may lead to a reduction in the generation of undesirable emissions. Many different approaches have been found to reduce the amount of emissions generated during the operation of an engine. Unfortunately, the implementation of these emission reduction approaches typically results in a decrease in the overall efficiency of the engine.

Additional efforts are being focused on improving engine efficiency to compensate for the efficiency loss due to the emission reduction systems. One such approach to improving the engine efficiency involves adjusting the actuation timing of the engine valves. For example, the actuation timing of the intake and exhaust valves may be modified to implement a variation on the typical diesel or Otto cycle known as the Miller cycle. In a “late intake” type Miller cycle, the intake valves of the engine are held open during a portion of the compression stroke of the piston.

The engine valves in an internal combustion engine are typically driven by a cam arrangement that is operatively connected to the crankshaft of the engine. The rotation of the crankshaft results in a corresponding rotation of a cam that drives one or more cam followers. The movement of the cam followers results in the actuation of the engine valves. The shape of the cam governs the timing and duration of the valve actuation. As described in U.S. Pat. No. 6,237,551 to Macor et al., issued on May 29, 2001, a “late intake” Miller cycle may be implemented in such a cam arrangement by modifying the shape of the cam to overlap the actuation of the intake valve with the start of the compression stroke of the piston.

However, a late intake Miller cycle may be undesirable under certain operating conditions. For example, a diesel engine operating on a late intake Miller cycle may be difficult to start when the engine is cold. This difficulty arises because diesel fuel combustion is achieved when an air and fuel mixture is pressurized to a certain level. Implementation of the late intake Miller cycle may reduce the amount of air and the amount of compression within each combustion chamber. The reduced compression combined with the reduced temperature of the engine results in a lower maximum pressure level of the air and fuel mixture. Thus, achieving combustion in a cold engine operating on a late intake Miller cycle may prove difficult.

As noted above, the actuation timing of a valve system driven by a cam arrangement is determined by the shape of the driving cam. Because the shape of the cam is fixed, this arrangement is inflexible and may not be changed during the operation of the engine. In other words, a conventional cam driven valve actuation system may not be modified to account for different operating conditions of the engine.

The present disclosure is directed to possibly addressing one or more of the drawbacks associated with some prior approaches.

### SUMMARY OF THE INVENTION

One exemplary aspect may relate to a method of operating an internal combustion engine including at least one cylinder and a piston slidable in the cylinder. The method may include supplying pressurized air from an intake manifold to an air intake port of a combustion chamber in the cylinder, and operating an air intake valve to open the air intake port to allow pressurized air to flow between the combustion chamber and the intake manifold substantially during a majority portion of a compression stroke of the piston. The operating may include directing fluid to a fluid actuator associated with the air intake valve.

Another exemplary aspect may relate to an internal combustion engine. The engine may include an engine block defining at least one cylinder, and a head connected with said engine block, the head including an air intake port, and an exhaust port. A piston may be slidable in the cylinder. A combustion chamber may be defined by said head, said piston, and said cylinder. An air intake valve may be movable to open and close the air intake port. The engine may also include an air supply system including at least one turbocharger fluidly connected to the air intake port. The engine may further include a source of fluid, a fluid actuator configured to maintain the air intake valve open, and a control valve configured to direct fluid from the source of fluid to the fluid actuator. In addition, the engine may include a fuel supply system operable to inject fuel into the combustion chamber.

A further exemplary aspect may relate to a method of operating an internal combustion engine including at least one cylinder and a piston slidable in the cylinder. The method may include imparting rotational movement to a first turbine and a first compressor of a first turbocharger with exhaust air flowing from an exhaust port of the cylinder, imparting rotational movement to a second turbine and a second compressor of a second turbocharger with exhaust air flowing from an exhaust duct of the first turbocharger, compressing air drawn from atmosphere with the second compressor, compressing air received from the second compressor with the first compressor, supplying pressurized air from the first compressor to an air intake port of a combustion chamber in the cylinder via an intake manifold, operating a fuel supply system to inject fuel directly into the combustion chamber, and operating an air intake valve to open the air intake port to allow pressurized air to flow between the combustion chamber and the intake manifold. The operating may include directing fluid to a fluid actuator associated with the air intake valve.

Yet another exemplary aspect may relate to a method of controlling an internal combustion engine having a variable compression ratio, said engine including a block defining a cylinder, a piston slidable in said cylinder, and a head connected with said block, said piston, said cylinder, and said head defining a combustion chamber. The method may include pressurizing air, supplying said air to an intake manifold of the engine, and maintaining fluid communication between said combustion chamber and the intake manifold during a portion of an intake stroke and through a portion of a compression stroke. The maintaining may include directing fluid to a fluid actuator associated with an air intake valve. Fuel may be injected directly into the combustion chamber.

An even further exemplary aspect may involve a method of operating an internal combustion engine including at least one cylinder and a piston slidable in the cylinder, the method may include supplying pressurized air from an intake manifold to an air intake port of a combustion chamber in the cylinder, and operating an air intake valve to open the air intake port to allow pressurized air to flow between the combustion chamber and the intake manifold substantially during a portion of a compression stroke of the piston. The operating may include directing fluid to a fluid actuator associated with the air intake valve. The method may also include injecting fuel into the combustion chamber after the intake valve is closed, wherein the injecting includes supplying a pilot injection of fuel at a crank angle before a main injection of fuel.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a combination diagrammatic and schematic illustration of an exemplary air supply system for an internal combustion engine in accordance with the invention;

FIG. 2 is a combination diagrammatic and schematic illustration of an exemplary engine cylinder in accordance with the invention;

FIG. 3 is a diagrammatic sectional view of the exemplary engine cylinder of FIG. 2;

FIG. 4 is a diagrammatic, schematic, cross-sectional view of the internal combustion engine;

FIG. 5 is a diagrammatic cross-sectional view of a cylinder and valve actuation assembly in accordance with an exemplary embodiment of the present invention;

FIG. 6A is a schematic and diagrammatic representation of a fluid supply system for a fluid actuator for an engine valve in accordance with an exemplary embodiment;

FIG. 6B is a schematic and diagrammatic representation of another exemplary embodiment of a fluid supply system for a fluid actuator for an engine valve;

FIG. 7 is a schematic and diagrammatic representation of a fluid supply system for a fluid actuator in accordance with another exemplary embodiment;

FIG. 8 is a cross-sectional view of an exemplary embodiment of a check valve for a fluid actuator;

FIG. 9 is a cross-sectional view of an exemplary embodiment of an accumulator for a fluid actuator;

FIG. 10A is a side sectional view of a fluid actuator and a-snubbing valve in accordance with an exemplary embodiment;

FIG. 10B is a side sectional view of a fluid actuator and a snubbing valve in accordance with another exemplary embodiment;

FIG. 11 is a graph illustrating an exemplary intake valve actuation as a function of engine crank angle in accordance with the present invention;

FIG. 12 is a graphic illustration of an exemplary valve actuation as a function of engine crank angle for an engine operating in accordance with the present invention;

FIG. 13 is a graph illustrating an exemplary fuel injection as a function of engine crank angle in accordance with the present invention;

FIG. 14 is a combination diagrammatic and schematic illustration of another exemplary air supply system for an internal combustion engine in accordance with the invention;

FIG. 15 is a combination diagrammatic and schematic illustration of yet another exemplary air supply system for an internal combustion engine in accordance with the invention; and

FIG. 16 is a combination diagrammatic and schematic illustration of an exemplary exhaust gas recirculation system included as part of an internal combustion engine in accordance with the invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

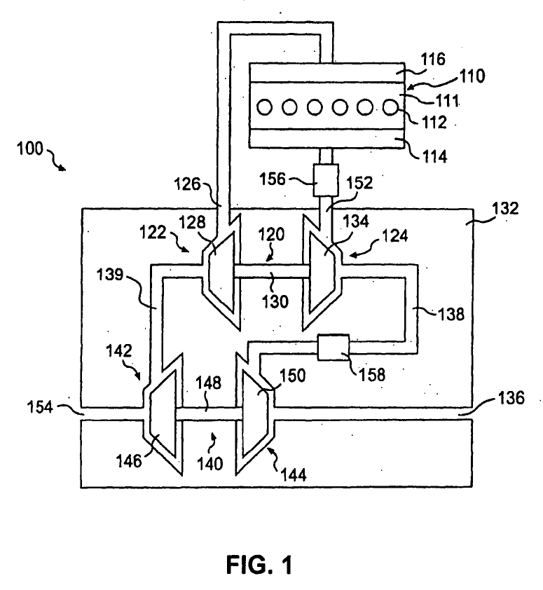

Referring to FIG. 1, an exemplary air supply system 244 for an internal combustion engine 110, for example, a four-stroke, diesel engine, is provided. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the exemplary embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.

The air supply system 244 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 ma y include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4:1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 244 may include an air cooler 156, for example, an aftercooler, between the compressor 124 and the intake manifold 114. The air cooler 156 may extract heat from the air to lower the intake manifold temperature and increase the air density. Optionally, the air supply system 244 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 244 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

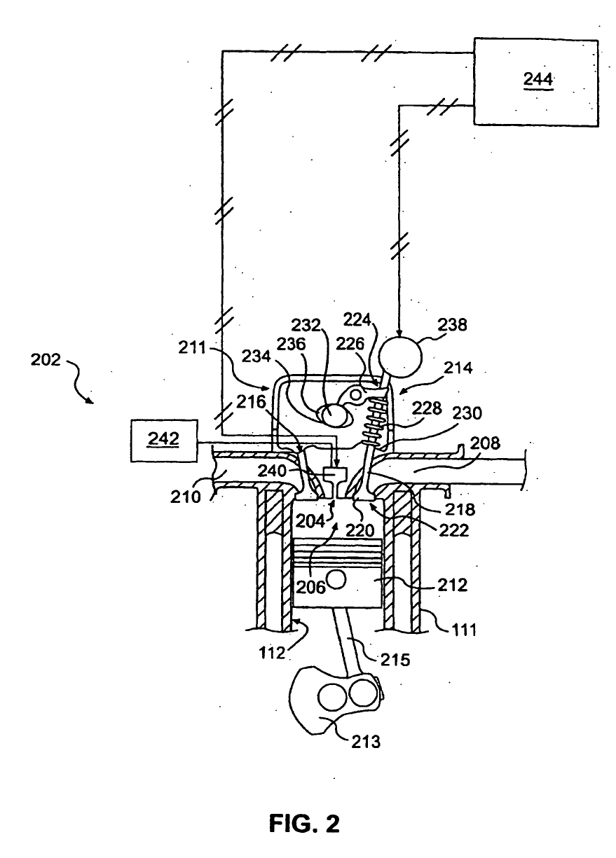

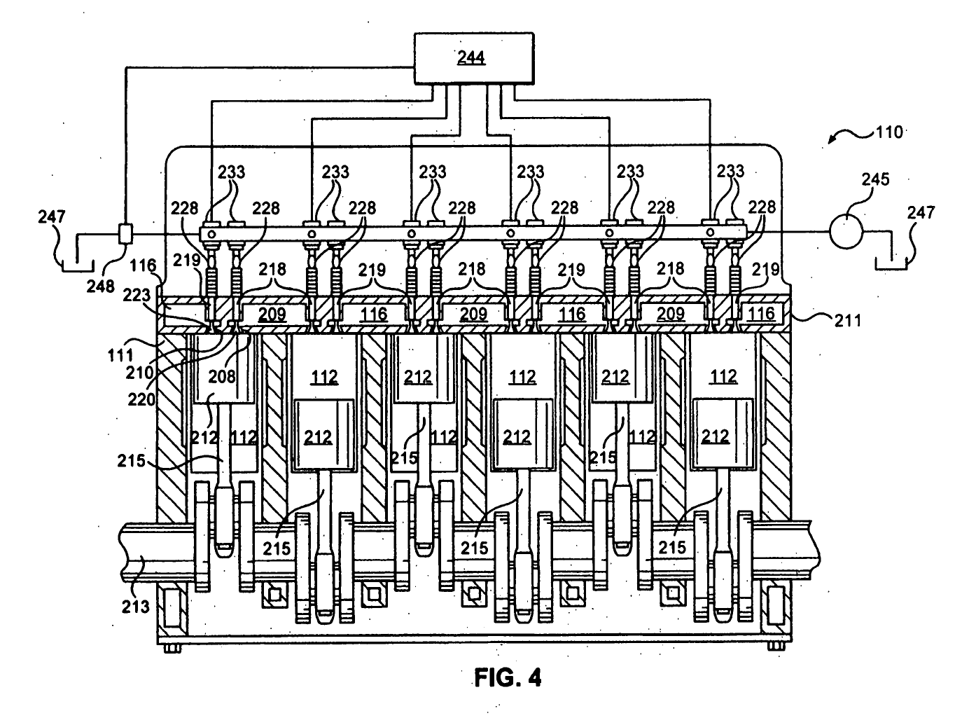

Referring now to FIGS. 2 and 4, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. As shown in FIG. 4, the engine 110 may include six cylinders 112 and six associated pistons 212. One skilled in the art will readily recognize that the engine 110 may include a greater or lesser number of pistons 212 and that the pistons 212 may be disposed in an “in-line” configuration, a “V” configuration, or any other conventional configuration. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 5400.

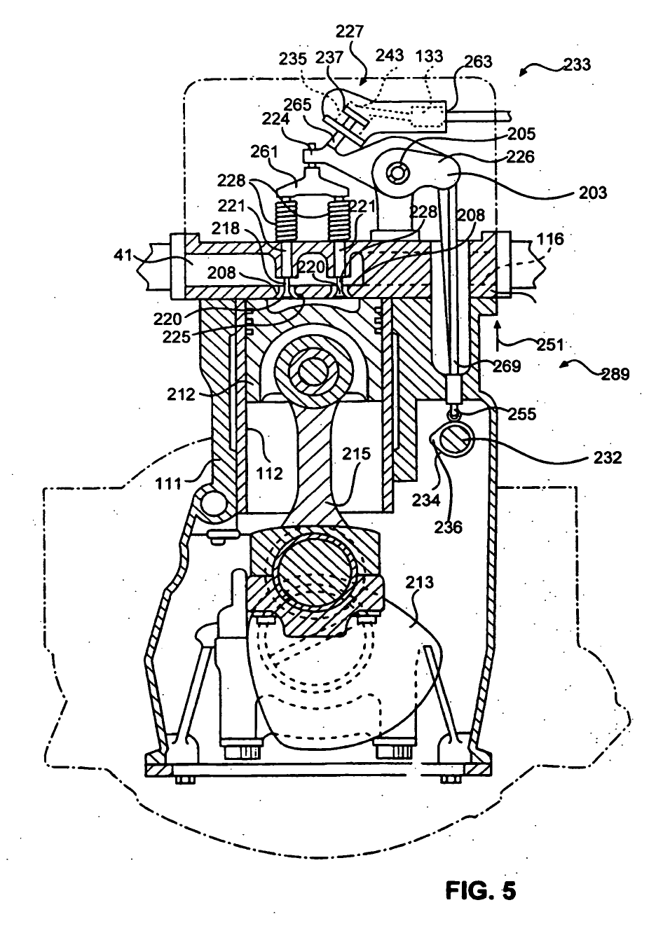

As further shown in FIG. 4, the cylinder head 211 defines an intake passageway 209 that leads to at least one intake port 208 for each cylinder 112. The cylinder head 211 may further define two or more intake ports 208 for each cylinder 112. As shown in FIG. 5, each intake port 208 may include a valve seat 225. One intake valve 218 is disposed within each intake port 208. At a first end 222 (FIG. 2) of intake valve 218, a head 220 is sized and arranged to selectively close intake port 208. When intake valve 218 is in its closed position, valve head 220 engages valve seat 225 to close intake port 208 and block fluid flow relative to cylinder 112. When intake valve 218 is lifted from the closed position, intake valve 218 allows a flow of fluid relative to cylinder 112.

The cylinder head 211 also defines at least one exhaust port 210 for each cylinder 112. Each exhaust port 210 leads from the respective cylinder 112 to an exhaust passageway 116. The cylinder head 211 may further define two or more exhaust ports 210 for each cylinder 112 (only one of which is illustrated in FIGS. 2 and 4). An exhaust valve 219 is disposed within each exhaust port 210. Each exhaust valve 219 includes a valve head 223 that is configured to selectively close, e.g., block, the respective exhaust port 210. As described in greater detail below, each exhaust valve 219 may be actuated to move or “lift” valve head 223 to thereby open the respective exhaust port 210. In a cylinder 112 having a pair of exhaust ports 210 and a pair of exhaust valves 219, the pair of exhaust valves 219 may be actuated by a single valve actuation assembly or by a pair of valve actuation assemblies.

The engine 110 includes a series of valve actuation assemblies (an exemplary valve actuation assembly 233 is illustrated in FIG. 5). One valve actuation assembly 233 (schematically shown in FIG. 2 as exhaust valve assembly 216) may be provided to move the exhaust valve 219 between its closed and open positions. Another valve actuation assembly 233 (schematically shown in FIG. 2 as intake valve assembly 214), may be provided to move intake valve element 218 between its closed and open positions.

Valve actuation assembly 233 optionally includes a bridge 261 that is connected to each valve head 220 through a pair of valve stems 221. A spring 228 may be disposed around each valve stem 221 (e.g., between cylinder head 211 and bridge 261). Spring 114 acts to bias both valve heads 220 into engagement with the respective valve seat 225 to thereby close each intake port 208.

As described in greater detail below, each intake valve 218 may be actuated to move or “lift” the valve head 220 to thereby open the respective intake port 208. In a cylinder 112 having a pair of intake ports 208 and a pair of intake valves 218, the pair of intake valves 218 may be actuated by a single valve actuation assembly 233 or by a pair of valve actuation assemblies 233. Each valve actuation assembly 233 may include a rocker arm 226 that includes a first end 224, a second end 203, and a pivot point 205. The first end 224 of the rocker arm 226 may be connected to bridge 261 and operatively engaged with the intake valve head 220 through a valve stem 221. The second end 203 of the rocker arm 226 may be connected to a cam assembly 289. For example, the rocker arm 226 may be operatively associated with a push rod 269, which includes a cam follower contacting a cam 234, as shown in FIG. 5, or the rocker arm 226 could be more directly associated with cam 234 (e.g., without a pushrod), as shown schematically in FIG. 2, where cam 234 acts directly on rocker arm 226 (other arrangements are also possible). The intake valve 218 may be movable between an open position permitting flow from the intake manifold 114 to enter the combustion cylinder 112 and a closed position substantially blocking flow from the intake manifold 114 to the combustion cylinder 112.

As shown in FIGS. 2 and 5, cam 234 may be mounted on a camshaft 232 and include one or more lobes 236 that may be arranged to operate the intake valve(s) 218 cyclically based on the configuration of the cam 234, the lobes 236, and the rotation of the camshaft 232 to achieve a desired intake valve timing. Cam 234 may be connected to crankshaft 213 through any means readily apparent to one skilled in the art, such as, for example, through a gear reduction assembly (not shown). As one skilled in the art will recognize, in the example of FIG. 5, rotation of cam 234 will cause cam follower 255 and associated push rod 269 to periodically reciprocate between an upper and a lower position.

The reciprocating movement of push rod 269 causes rocker arm 226 to pivot about pivot 205. When push rod 269 moves in the direction indicated by arrow 251, rocker arm 226 will pivot and move bridge 261 in the opposite direction. The movement of bridge 261 causes each intake valve 218 to lift and open intake ports 208. As cam 234 continues to rotate, springs 228 will act on bridge 261 to return each intake valve 218 to the closed position.

In this manner, the shape and orientation of cam 234 may at least partially control the timing of the actuation of intake valves 218. As one skilled in the art will recognize, cam 234 may be configured to coordinate the actuation of intake valves 218 with the movement of piston 212. For example, intake valves 218 may be actuated to open intake ports 208 when piston 212 is in its intake stroke (e.g., withdrawing within cylinder 112) to allow air to flow from intake passageway 209 into cylinder 112. In an embodiment, the intake lobe 236 may be configured to operate the intake valve 218 in a conventional Otto or diesel cycle, whereby the intake valve 218 moves to its closed position from between about 100 before bottom dead center of the intake stroke and about 100 after bottom dead center of the compression stroke. In some alternative embodiments, the lobe 236 may be configured to cause the intake valve 218 to move to its closed position prior to bottom dead center to provide early closing Miller cycle operation, which may be altered via a closing mechanism 238 shown in FIG. 2 to selectively extend the closing time of the intake valve 218.

A similar valve actuation assembly may be connected to exhaust valves 219. A second cam (not shown) may be connected to crankshaft 213 to control the actuation timing of exhaust valves 219. Exhaust valves 219 may be actuated to open exhaust ports 210 when piston 212 is advancing within cylinder 112 to allow exhaust to flow from cylinder 112 into exhaust passageway 116.

Alternatively (or additionally), the intake valves and/or the exhaust valve may be operated hydraulically, pneumatically, electronically, or by any combination of mechanics, hydraulics, pneumatics, and/or electronics. For example, the valve may be operated via a fluid actuator 227 shown in FIG. 5, either with or without cam 234.

As shown schematically in FIG. 2, variable intake valve closing mechanism 238 may be structured and arranged to selectively interrupt cyclical movement of and extend the closing timing of the intake valve 218. In some embodiments described below, the valve closing mechanism may include a fluid actuator 227 (e.g., as shown in FIG. 5) described below. The variable intake valve closing mechanism 238 may be operated hydraulically (e.g., via fluid actuator 227), pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 enables the engine 110 to operate under a conventional Otto or diesel cycle, a variable early-closing Miller cycle, and/or a variable late-closing Miller cycle.

As shown in the example FIG. 1, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crankshaft is at or near a bottom dead center position of a compression stroke 407 (or earlier, i.e., before 540° crank angle), to about 650° crank angle, that is, about 70° before top center of the combustion stroke 508. Thus, the intake valve 218 may be held open for a majority portion of the compression stroke 407, that is, for more than half of the compression stroke 407, e.g., the first half of the compression stroke 407 and a portion of the second half of the compression stroke 407.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 and/or the fuel injector assembly 240 based on one or more engine conditions, for example, engine speed, load, pressure, and/or temperature in order to achieve a desired engine performance. The controller 244 may include an electronic control module that has a microprocessor and a memory. As is known to those skilled in the art, the memory may be connected to the microprocessor and store an instruction set and variables. Associated with the microprocessor and part of electronic control module are various other known circuits such as, for example, power supply circuitry, signal conditioning circuitry, and solenoid driver circuitry, among others.

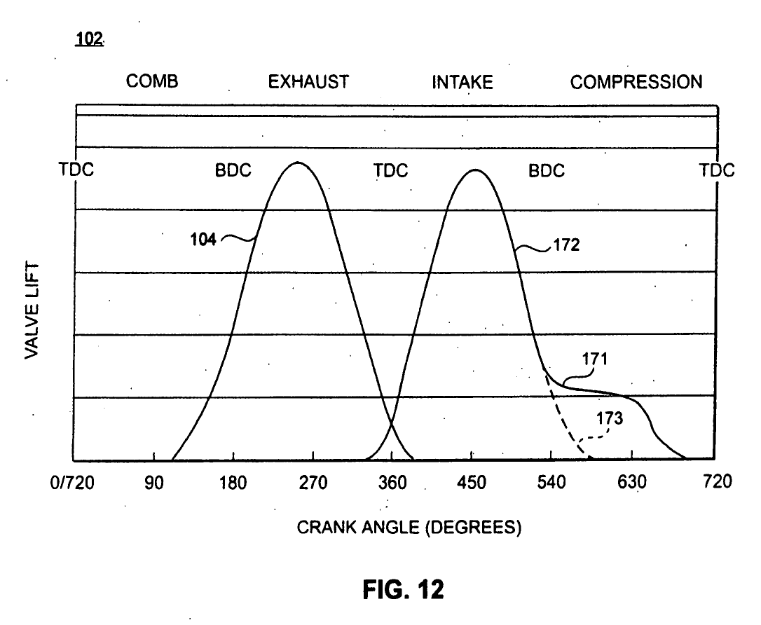

Engine 110 may be further equipped with a sensor configured to monitor the crank angle of crankshaft 213 to thereby determine the position of pistons 212 within their respective cylinders 112. The crank angle of crankshaft 213 may be related to actuation timing of intake valves 218 and exhaust valves 219. An exemplary graph 102 indicating one of many possible relationships between valve actuation timing and crank angle is illustrated in FIG. 12. As shown by graph 102, exhaust valve actuation 104 may be timed to substantially coincide with the exhaust stroke of piston 212 and intake valve actuation 172 may be timed to substantially coincide with the intake stroke of piston 212. Many other variations are possible.

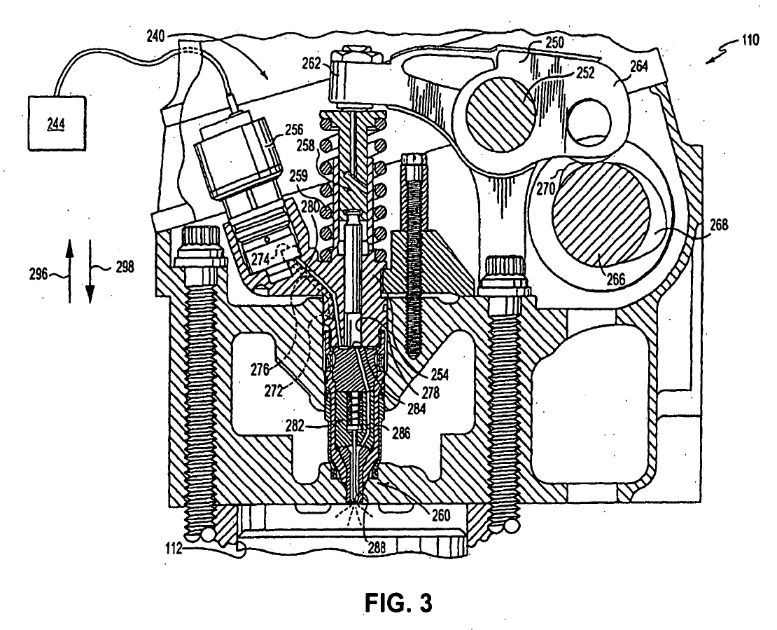

Referring now to FIG. 3, each fuel injector assembly 240 may be associated with an injector rocker arm 250 pivotally coupled to a rocker shaft 252. Each fuel injector assembly 240 may include an injector body 254, a solenoid 256, a plunger assembly 258, and an injector tip assembly 260. A first end 262 of the injector rocker arm 250 may be operatively coupled to the plunger assembly 258. The plunger assembly 258 may be biased by a spring 259 toward the first end 262 of the injector rocker arm 250 in the general direction of arrow 296.

A second end 264 of the injector rocker arm 250 may be operatively coupled to a camshaft 266. More specifically, the camshaft 266 may include a cam lobe 267 having a first bump 268 and a second bump 270. The camshafts 232, 266 and their respective lobes 236, 267 may be combined into a single camshaft (not shown) if desired. The bumps 268, 270 may be moved into and out of contact with the second end 264 of the injector rocker arm 250 during rotation of the camshaft 266. The bumps 268, 270 may be structured and arranged such that the second bump 270 may provide a pilot injection of fuel at a predetermined crank angle before the first bump 268 provides a main injection of fuel. It should be appreciated that the cam lobe 267 may have only a first bump 268 that injects all of the fuel per cycle.

When one of the bumps 268, 270 is rotated into contact with the injector rocker arm 250, the second end 264 of the injector-rocker arm 250 is urged in the general direction of arrow 296. As the second end 264 is urged in the general direction of arrow 296, the rocker arm 250 pivots about the rocker shaft 252 thereby causing the first end 262 to be urged in the general direction of arrow 298. The force exerted on the second end 264 by the bumps 268, 270 is greater in magnitude than the bias generated by the spring 259, thereby causing the plunger assembly 258 to be likewise urged in the general direction of arrow 298. When the camshaft 266 is rotated beyond the maximum height of the bumps 268, 270, the bias of the spring 259 urges the plunger assembly 258 in the general direction of arrow 296. As the plunger assembly 258 is urged in the general direction of arrow 296, the first end 262 of the injector rocker arm 250 is likewise urged in the general direction of arrow 296, which causes the injector rocker arm 250 to pivot about the rocker shaft 252 thereby causing the second end 264 to be urged in the general direction of arrow 298.

The injector body 254 defines a fuel port 272. Fuel, such as diesel fuel, may be drawn or otherwise aspirated into the fuel port 272 from the fuel rail 242 when the plunger assembly 258 is moved in the general direction of arrow 296. The fuel port 272 is in fluid communication with a fuel valve 274 via a first fuel channel 276. The fuel valve 274 is, in turn in fluid communication with a plunger chamber 278 via a second fuel channel 280.

The solenoid 256 may be electrically coupled to the controller 244 and mechanically coupled to the fuel valve 274. Actuation of the solenoid 256 by a signal from the controller 244 may cause the fuel valve 274 to be switched from an open position to a closed position. When the fuel valve 274 is positioned in its open position, fuel may advance from the fuel port 272 to the plunger chamber 278, and vice versa. However, when the fuel valve 274 is positioned in its closed positioned, the fuel port 272 is isolated from the plunger chamber 278.

The injector tip assembly 260 may include a check valve assembly 282. Fuel may be advanced from the plunger chamber 278, through an inlet orifice 284, a third fuel channel 286, an outlet orifice 288, and into the cylinder 112 of the engine 110.

Thus, it should be appreciated that when one of the bumps 268, 270 is not in contact with the injector rocker arm 16, the plunger assembly 258 is urged in the general direction of arrow 296 by the spring 259 thereby causing fuel to be drawn into the fuel port 272 which in turn fills the plunger chamber 278 with fuel. As the camshaft 266 is further rotated, one of the bumps 268, 270 is moved into contact with the rocker arm 250, thereby causing the plunger assembly 258 to be urged in the general direction of arrow 298. If the controller 244 is not generating an injection signal, the fuel valve 274 remains in its open position, thereby causing the fuel which is in the plunger chamber 278 to be displaced by the plunger assembly 258 through the fuel port 272. However, if the controller 244 is generating an injection signal, the fuel valve 274 is positioned in its closed position thereby isolating the plunger chamber 278 from the fuel port 272. As the plunger assembly 258 continues to be urged in the general direction of arrow 298 by the camshaft 266, fluid pressure within the fuel injector assembly 240 increases. At a predetermined pressure magnitude, for example, at about 5500 psi (38 MPa), fuel is injected into the cylinder 112. Fuel will continue to be injected into the cylinder 112 until the controller 244 signals the solenoid 256 to return the fuel valve 274 to its open position.

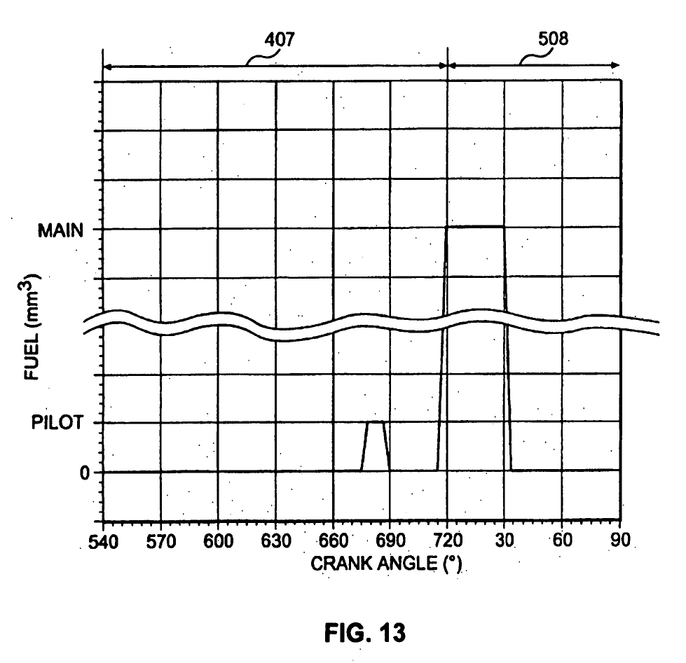

As shown in the exemplary graph of FIG. 13, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 100 before top dead center of the compression stroke 407 and about 45° after commencement of the pilot injection. Generally, the pilot injection may commence when the crankshaft 213 is about 40-50′ before top dead center of the compression stroke 407 and may last for about 10-150 crankshaft rotation. The main injection may commence when the crankshaft 213 is between about 10° before top dead center of the compression stroke 407 and about 120 after top dead center of the combustion stroke 508. The main injection may last for about 2045° crankshaft rotation. The pilot injection may use a desired portion of the total fuel used, for example about 10%.

As shown in FIG. 5, fluid actuator 227 includes an actuator cylinder 235 that defines an actuator chamber 243. An actuator piston 237 is slidably disposed within actuator cylinder 235 and is connected to an actuator rod 265. A return spring (not shown) may act on actuator piston 237 to return actuator piston 237 to a home position. Actuator rod 265 may be engageable with an end 224 of rocker arm 226.

A fluid line 263 is connected to actuator chamber 243. Pressurized fluid may be directed through fluid line 263 into actuator chamber 243 to move actuator piston 237 within actuator cylinder 235. Movement of actuator piston 237 causes actuator rod 265 to engage end 224 of rocker arm 226. Fluid may be introduced to actuator chamber 243 when intake valves 218 are in the open position to move actuator rod 265 into engagement with rocker arm 226 to thereby hold intake valves 218 in the open position and delay the closing of the intake-valve(s) 218. Alternatively, fluid may be introduced to actuator chamber 243 when intake valves 218 are in the closed position to move actuator rod 265 into engagement with rocker arm 226 and pivot rocker arm 226 about pivot 230 to thereby open intake valves 218 (e.g.; to selectively open the intake valves during the compression stroke and/or possibly enable valve opening without using a cam actuation).

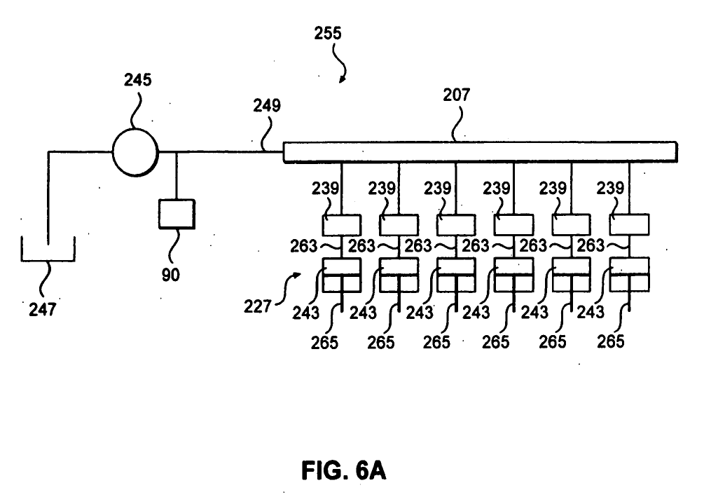

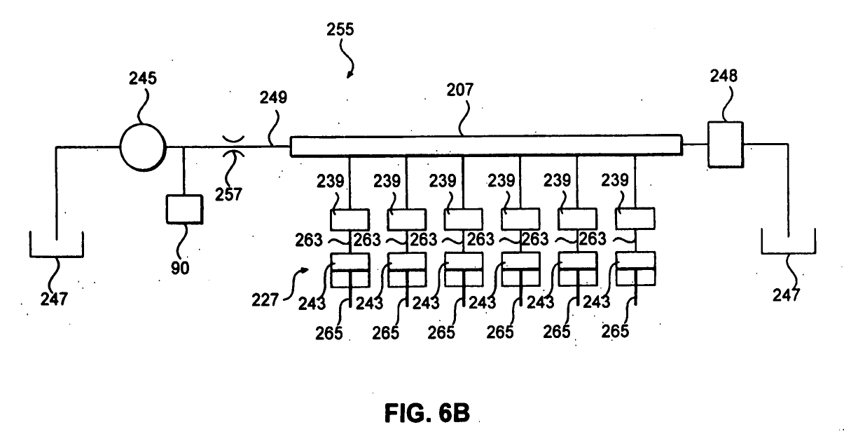

As illustrated in FIGS. 4, 6A, and 6B, a source of fluid 245, which is connected to a tank 247, supplies pressurized fluid to fluid actuator 227. Tank 247 may store any type of fluid readily apparent to one skilled in the art, such as, for example, hydraulic fluid, fuel, or transmission fluid. Source of fluid 245 may be part of a lubrication system, such as typically accompanies an internal combustion engine. Such a lubrication system may provide pressurized oil having a pressure of, for example, less than 700 KPa (244 psi) or, more particularly, between about 210 KPa and 620 KPa (30 psi and 90 psi). Alternatively, the source of fluid may be a pump configured to provide oil at a higher pressure, such as, for example, between about 10 MPa and 35 MPa (1450 psi and 5000 psi).

A fluid supply system 255 connects source of fluid 245 with fluid actuator 227. In the exemplary embodiment of FIG. 6A, source of fluid 245 is connected to a fluid rail 207 through fluid line 249. Fluid rail 207 supplies pressurized fluid from source of fluid 245 to a series of fluid actuators 227. Each fluid actuator 227 may be associated with either the intake valves 218 or the exhaust valves 219 of a particular engine cylinder 112 (referring to FIG. 3). Fluid lines 263 direct pressurized fluid from fluid rail 207 into the actuator chamber 243 of each fluid actuator 227.

A directional control valve 239 may be disposed in each fluid line 263. Each directional control valve 239 may be opened to allow pressurized fluid to flow between fluid rail 207 and actuator chamber 243. Each directional control valve 239 may be closed to prevent pressurized fluid from flowing between fluid rail 207 and actuator chamber 243. Directional control valve 239 may be normally biased into a closed position and actuated to allow fluid to flow through directional control valve 239. Alternatively, directional control valve 239 may be normally biased into an open position and actuated to prevent fluid from flowing through directional control valve 239. One skilled in the art will recognize that directional control valve 239 may be any type of controllable valve, such as, for example a two coil latching valve.

One skilled in the art will recognize that fluid supply system 255 may have a variety of different configurations. For example, as illustrated in FIG. 6B, a restrictive orifice 257 may be positioned in fluid line 249 between source of fluid 245 and a first end of fluid rail 242. A control valve 248 may also be disposed in fluid line 249. Control valve 248 may be connected to an opposite end of fluid rail 242 and lead to tank 247. Control valve 248 may be opened to allow a flow of fluid through restrictive orifice 257 and fluid rail 242 to tank 247. Control valve 248 may be closed to allow a build up of pressure in the fluid within fluid rail 242 and prevent pressurized fluid from flowing from source 245 to fluid rail 207.

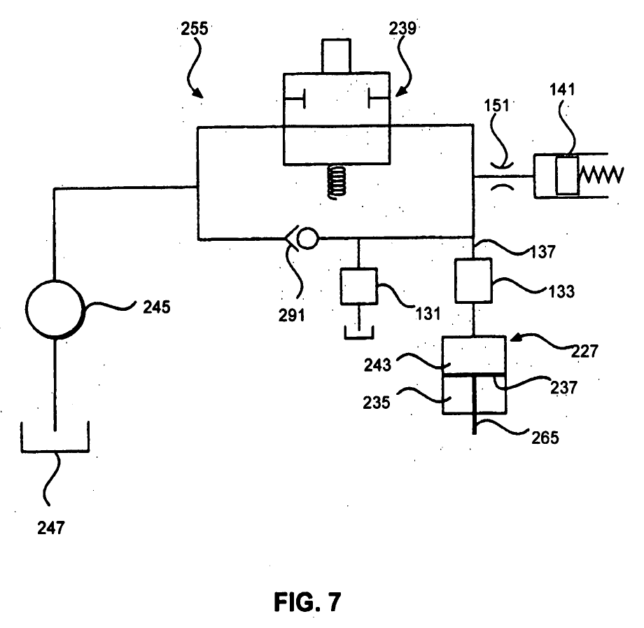

In addition, as illustrated in FIG. 7, fluid supply system 255 may include a check valve 291 placed in parallel with directional control valve 239 between control valve 248 and fluid actuator 227. The check valve 291 may be configured to allow fluid to flow in the direction from control valve 248 to fluid actuator 227.

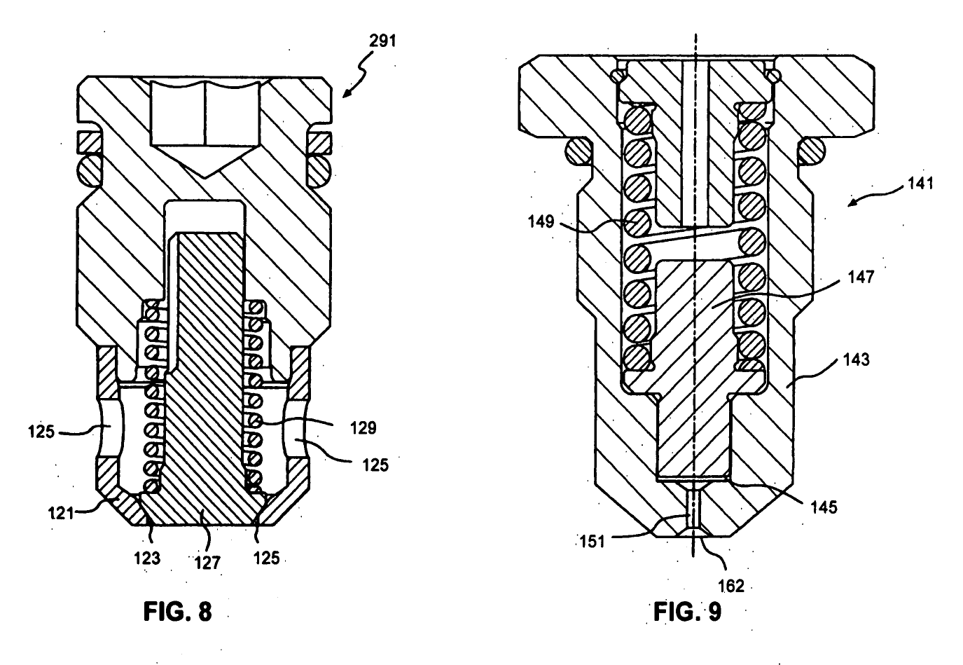

Referring now to FIG. 8, the check valve 291 may be, for example, a poppet-type check valve, a plate-type check valve, or the like. The exemplary check valve 282 includes a housing 121 that defines an inlet passageway 123 and includes a seat 125. A poppet 127 is disposed proximate the seat 125. A spring 129 acts on the poppet 127 to engage the poppet 127 with the seat 125. The poppet 127 may be disengaged from the seat 125 to create a fluid passage between the inlet passageway 123 and a fluid outlet 125.

The check valve 291 will open when the poppet 127 is exposed to a pressure differential that is sufficient to overcome the force of the spring 129. The poppet 127 will disengage from the seat 125 when a force exerted by pressurized fluid in the inlet passageway 123 is greater than the combination of a force exerted by fluid in the fluid outlet 125 and the force of the spring 129. If, however, the combination of the force exerted by fluid in the fluid outlet 125 and the force of the spring 129 is greater than the force exerted by the pressurized fluid in the inlet passageway 123, the poppet 127 will remain engaged with the seat 125. In this manner, the check valve 291 may ensure that fluid flows only from the source of fluid 245 to the fluid actuator 227, i.e. from the inlet passageway 123 to the fluid outlet 125. One skilled in the art will recognize that other types of check valves, such as, for example, a ball-type check valve, may alternatively or additionally be used.

As also shown in FIG. 7, fluid supply system 255 may include an air bleed valve 131. Air bleed valve 131 may be any device readily apparent to one skilled in the art as capable of allowing air to escape a hydraulic system. For example, air bleed valve 131 may be a spring biased ball valve that allows air to flow through the valve, but closes when exposed to fluid pressure.

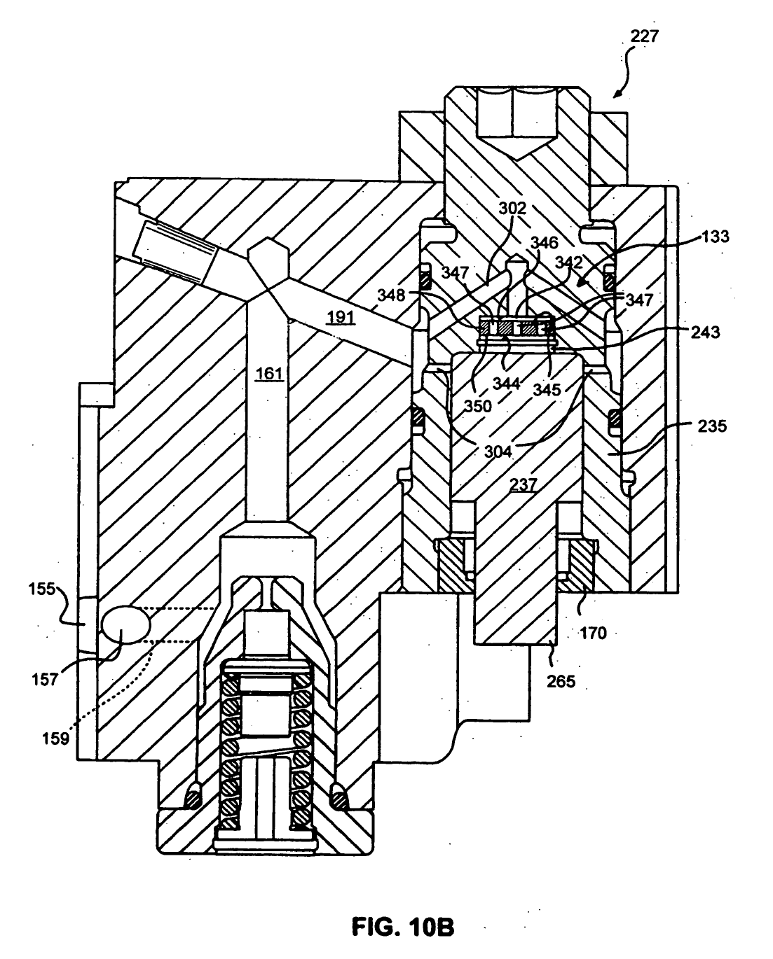

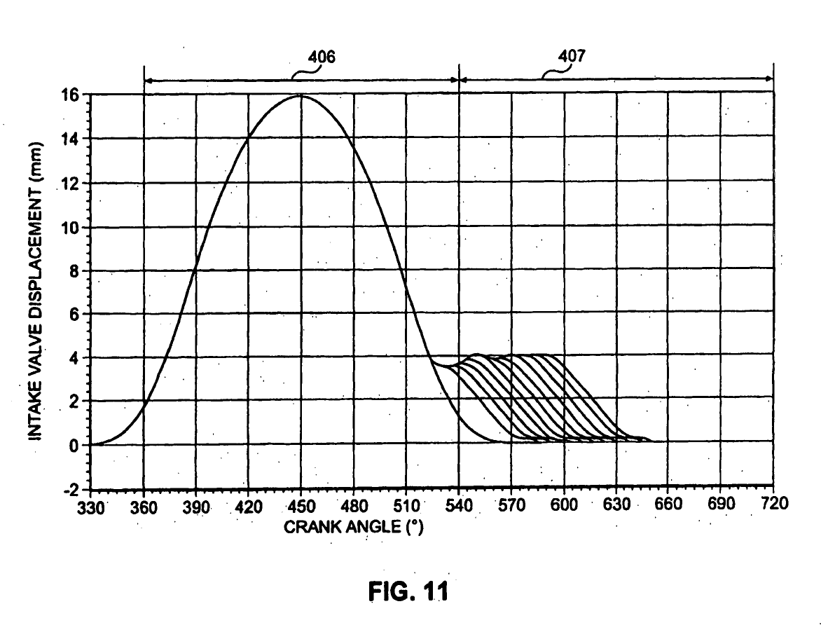

In addition, a snubbing valve 133 may be disposed in fluid line 137 leading to actuator chamber 243. The snubbing valve 133 may be configured to restrict the flow of fluid through fluid line 137, as will be described more fully below with respect to FIGS. 10A and 10B. For example, snubbing valve 133 may be configured to decrease the rate at which fluid exits actuator chamber 243 to thereby slow the rate at which intake valve 218 closes.

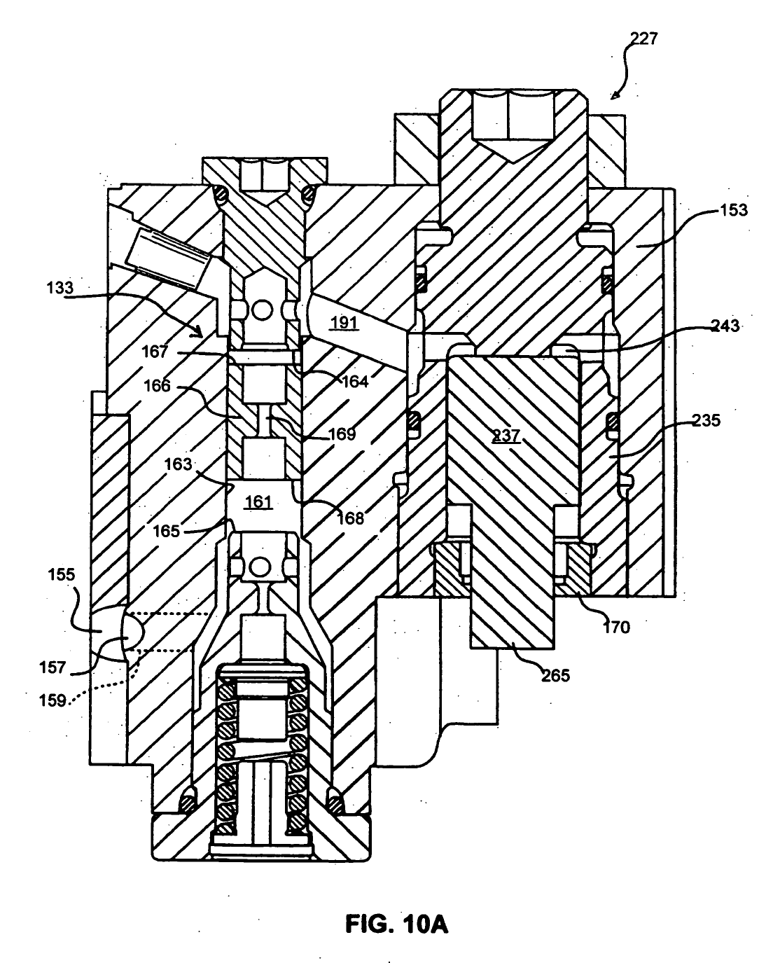

The fluid supply system 255 may also include an accumulator 141. An exemplary embodiment of the accumulator 141 is illustrated in FIG. 9. As shown, the exemplary accumulator 141 includes a housing 143 that defines a chamber 145. A piston 147 is slidably disposed in the chamber 145. A spring 149 is disposed in the housing 143 and acts on the piston 147 to move the piston 147 relative to the housing 143 to minimize the size of the chamber 145. Once skilled in the art may recognize that other types of accumulators, such as for example, a bladder-type accumulator, may alternatively or additionally be used.

As also shown in FIG. 9, a restrictive orifice 151 may be disposed in the inlet 162 to accumulator 141. The restrictive orifice 151 is configured to restrict the rate at which fluid may flow between the accumulator chamber 145 and inlet 162. As described in greater detail below, the combination of accumulator 141 and restrictive orifice 151 act to dampen oscillations in actuator chamber 243 and fluid line 263, which may cause actuator piston 237 to oscillate.

The components of the fluid actuator 227 may be contained within a single housing that is mounted on the engine 110 to allow the actuator rod 265 to engage the rocker arm 226. Alternatively, the components of the fluid actuator 227 may be contained in separate housings. One skilled in the art will recognize that space considerations will impact the location of the components of the fluid actuator 227 relative to the engine 110.

Referring now to FIGS. 10A and 10B, the fluid actuator 227 and the snubbing valve 133 may be housed in a housing 153. The housing 153 includes an inlet 155 having an opening 157 leading to a first fluid passageway 159. The first fluid passageway 159 leads to a second fluid passageway 161, which, in turn, leads to a third fluid passageway 191 that leads to the actuator chamber 243. Referring to the embodiments of FIGS. 6A and 6B, the directional control valve 239 may be opened to allow fluid to flow in either direction through the inlet 155 and the first fluid passageway 159. One skilled in the art will recognize that the inlet 155 may have alternative configurations. For example, the inlet 155 may include multiple openings (not shown) that lead to multiple fluid passageways (not shown). For example, referring to FIG. 7, the check valve 291 and the directional control valve 239 may be opened to allow fluid to flow in either direction through two separate openings that lead to two fluid passageways, which, in turn, lead to the second fluid passageway 161.

The accumulator 141 may be disposed proximate the second fluid passageway 161 so that the inlet 162 of the accumulator 141 opens to the second fluid passageway 161. This allows fluid from the first fluid passageway 159 to flow through the inlet 162 to the accumulator 141. The restricted orifice 151 (referring to FIG. 9) restricts the amount of fluid that may flow from the second fluid passageway 161 into the accumulator 141.

As illustrated in FIG. 10A, the snubbing valve 133 may be disposed in the second fluid passageway 161. The second fluid passageway 161 may, at least in part, define a cavity 163 having a first end 164 and a second end 165. The snubbing valve 133 is positioned within the cavity 163 and includes a valving member 166 having a first end 167, a second end 168, and a passage 169 extending between the first and second ends 167, 168. For example, the passage 169 may extend axially through the valving member 166.

The valving member 166 is movable between a first location, at which the first end 167 of the valving member 166 is against the first end 164 of the cavity 163, and a second location, at which the second end 168 of the valving member 166 is against the second end 165 of the cavity 163.

Referring now to FIG. 10B, the snubbing valve 133 may be disposed between the third fluid passageway 191 and the fluid actuator 227. The housing 153 may define a first fluid conduit 302, a second fluid conduit 304, and a cavity 342. The cavity 342 may include a first end 344 and a second end 346. The first end 344 of the cavity 342 may be defined, for example, by a washer or other ring-like structure, such as a metal washer. The snubbing valve 133 is positioned within the cavity 342 and includes a valving member 348 having a first end 350, a second end 345, and at least one passage 347 extending between the first and second ends 350, 345. For example, the passages 347 may extend axially through the valving member 348. The valving member 348 is movable between a first location, at which the first end 350 of the valving member 348 is against the first end 344 of the cavity 342, and a second location, at which the second end 345 of the valving member 348 is against the second end 346 of the cavity 342.

Controller 244 may be programmed to control one or more aspects of the operation of engine 110. For example, controller 244 may be programmed to control the valve actuation assembly, the fuel injection system, and/or any other function readily apparent to one skilled in the art. Controller 244 may control engine 110 based on the current operating conditions of the engine and/or instructions received from an operator.

Controller 244 may be further programmed to receive information from one or more sensors operatively connected with engine 110. Each of the sensors may be configured to sense one or more operational parameters of engine 110. For example, with reference to FIG. 6A, a sensor 90 may be connected with fluid supply system 255 to sense the temperature of the fluid within fluid supply system 255. One skilled in the art will recognize that many other types of sensors may be used in conjunction with or independently of sensor 90. For example, engine 110 may be equipped with sensors configured to sense one or more of the following: the temperature of the engine coolant, the temperature of the engine, the ambient air temperature, the engine speed, the load on the engine, and the intake air pressure. It should be appreciated that the functions of the controller 244 may be performed by a single controller or by a plurality of controllers. Similarly, spark timing in a natural gas engine may provide a similar function to fuel injector timing of a compression ignition engine.

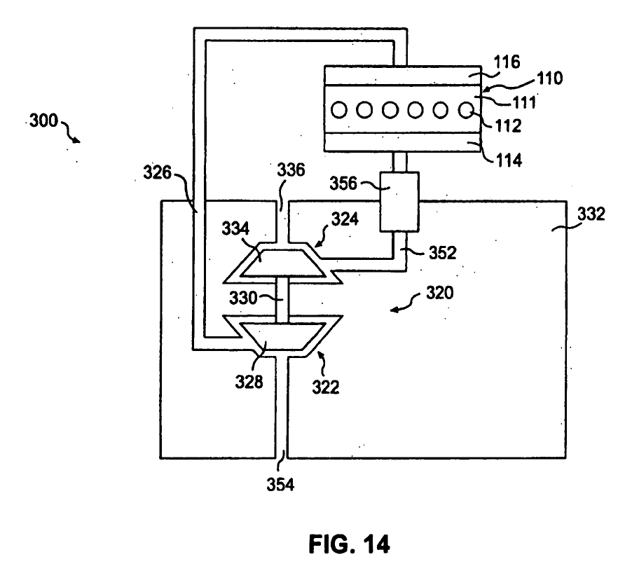

FIG. 14 is a combination diagrammatic and schematic illustration of an alternative exemplary air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake manifold 114.

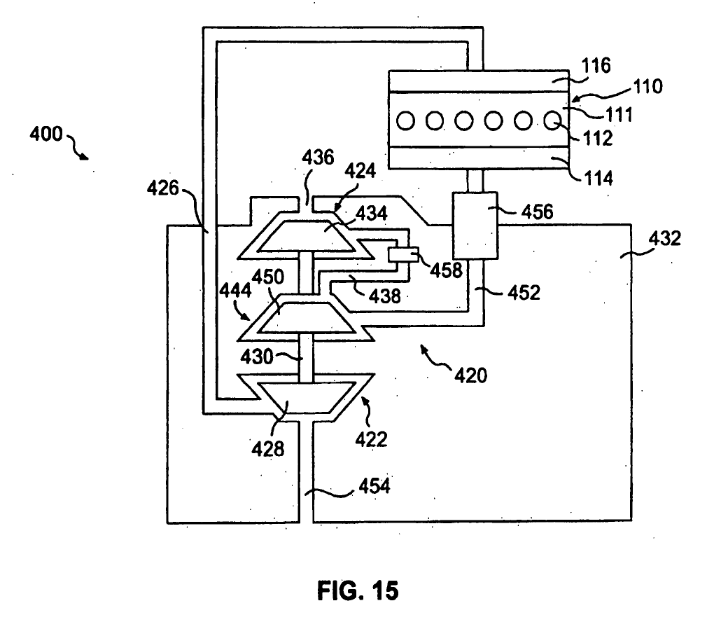

FIG. 15 is a combination diagrammatic and schematic illustration of another alternative exemplary air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4:1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

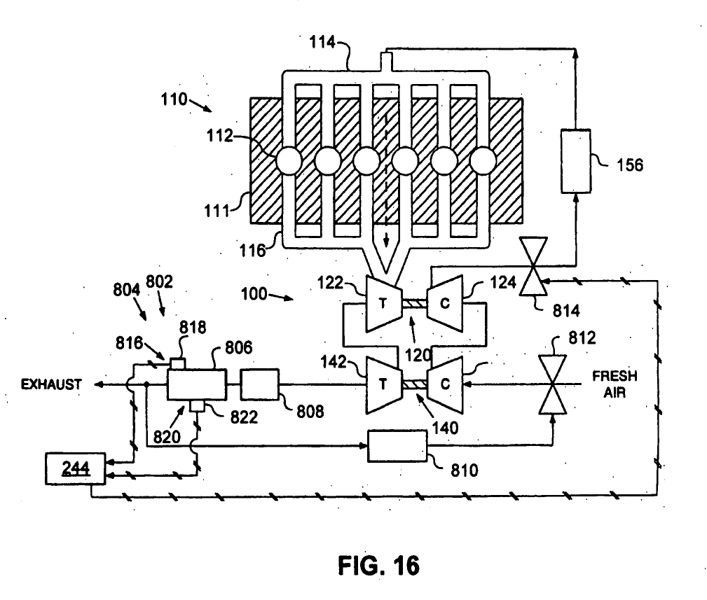

FIG. 16 shows an exemplary exhaust gas recirculation (EGR) system 804 in an exhaust system 802 of combustion engine 110 is shown. Combustion engine 110 includes intake manifold 114 and exhaust manifold 116. Engine block 111 provides housing for at least one cylinder 112. FIG. 16 depicts six cylinders 112; however, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 16, the air supply system 244 is shown as a two-stage turbocharger system. Air supply system 244 includes first turbocharger 120 having turbine 122 and compressor 124. Air supply system 244 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation of the present invention. Other types of turbocharger systems, such as a high pressure ratio single-stage turbocharger system, a variable geometry turbocharger system, and the like, may be used instead. Alternatively, one or more superchargers or other types of compressors may be used.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 16 is typical of a low pressure EGR system in an internal combustion engine. Alternatively, variations of the EGR system 804 may be used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De-NOₓ, catalyst to further reduce NOₓ, emissions. A particulate matter (PM) filter 806 receives exhaust gases from oxidation catalyst 808. Although oxidation catalyst 808 and PM filter 806 are shown as separate items, they may alternatively be combined into one package.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120, 140. EGR cooler 810 may be of a type well known in the art, for example a jacket water or an air to gas heat exchanger type.

A means 816 for determining pressure within the PM filter 806 is shown. In one embodiment, the means 816 for determining pressure includes a pressure sensor 818. However, other alternate-means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. The means 820 for determining flow of exhaust gases may include a flow sensor 822. The flow sensor 822 may be used alone to determine pressure in the PM filter 806 based on changes in flow of exhaust gases, or may be used in conjunction with the pressure sensor 818 to provide more accurate pressure change determinations.

### INDUSTRIAL APPLICABILITY

During use, the internal combustion engine 110 may operate in a known manner using, for example, the diesel principle of operation. Referring to the exemplary air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The exemplary fuel supply system 200 and cylinder 112 shown in FIGS. 2 and 5 may be used with each of the exemplary air supply systems 244, 300, 400. Compressed air is supplied to the combustion chamber 206 via the intake port 208, and exhaust air exits the combustion chamber 206 via the exhaust port 210. The intake valve 218 and the exhaust valve 219 may be controllably operated to direct airflow into and out of the combustion chamber 206.

In a conventional Otto or diesel cycle mode, the intake valve 218 moves from the closed position to the open position in a cyclical fashion to allow compressed air to enter the combustion chamber 206 of the cylinder 112 at near top center of the intake stroke 406 (about 360° crank angle), as shown in FIG. 11. At near bottom dead center of the compression stroke (about 540° crank angle), the intake valve 218 moves from the open position to the closed position to block additional air from entering the combustion chamber 206. Fuel may then be injected from the fuel injector assembly 240 at near top dead center of the compression stroke (about 720° crank angle).

In a Miller cycle engine, the conventional Otto or diesel cycle is modified by moving the intake valve 218 from the open position to the closed position at either some predetermined time before bottom dead center of the intake stroke 406 (i.e., before 540° crank angle) or some-predetermined time after bottom dead center of the compression stroke 407 (i.e., after 540° crank angle). In a conventional late-closing Miller cycle, the intake valve 218 is moved from the first position to the second position during a first portion of the first half of the compression stroke 407.

The variable intake valve closing mechanism 238 enables the engine 110 to be operated in a late-closing Miller cycle, an early-closing Miller cycle, and/or a conventional Otto or diesel cycle. Further, injecting a substantial portion of fuel after top dead center of the combustion stroke 508, as shown in FIG. 13, may reduce NOₓ emissions and increase the amount of energy rejected to the exhaust manifold 116 in the form of exhaust fluid. Use of a high-efficiency turbocharger 320, 420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying (and/or advancing) movement of the intake valve 218 from the open position to the closed position may reduce the compression temperature in the combustion chamber 206. The reduced compression temperature may further reduce NOₓ emissions.

The controller 244 may operate the variable intake valve closing mechanism 238 (e.g., fluid actuator 227) to vary the timing of the intake valve 218 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying (and/or advancing) closing of the intake valve 218, the controller 244 may control the cylinder pressure during the compression stroke of the piston 212. For example, late (and/or early) closing of the intake valve may reduce the compression work that the piston 212 performs without compromising cylinder pressure and while maintaining a standard expansion ratio and a suitable air/fuel ratio.

The following discussion describes one possible implementation of a late intake Miller cycle in a single cylinder 112 of the engine 110. One skilled in the art will recognize that the system according to some embodiments may be used to selectively implement a late intake Miller cycle in all cylinders of the engine 110 in the same or a similar manner.

When the engine 110 is operating under normal operating conditions, the controller 244 may implement a late intake Miller cycle by selectively actuating the fluid actuator 227 to hold the intake valve 218 open for a first portion of the compression stroke of the piston 212. This may be accomplished by moving the directional control valve 239 to the open position when the piston 212 starts an intake stroke. (In the embodiment of FIG. 6B, the control valve 248 is closed to implement a late intake Miller cycle.) This allows pressurized fluid to flow from the source of fluid 245 through the fluid rail 207 and into the actuator chamber 243. The force of the fluid entering the actuator chamber 243 moves the actuator piston 237 so that the actuator rod 265 follows the end 224 of the rocker arm 226 as the rocker arm 226 pivots to open the intake valves 218. The distance and rate of movement of the actuator rod 265 will depend upon the configuration of the actuator chamber 243 and the fluid supply system 255. When the actuator chamber 243 is filled with fluid and the rocker arm 226, the actuator rod 265 will engage the end 222 of the rocker arm 226.

The fluid supply system 255 may be configured to supply a flow rate of fluid to the fluid actuator 227 to fill the actuator chamber 243 before the cam 234 returns the intake valves 218 to the closed position. In the embodiment of the fluid supply system 255 illustrated in FIG. 7, pressurized fluid may flow through both the directional control valve 239 and the check valve 291 into the actuator chamber 243. Alternatively, the directional control valve 239 may remain in a closed position and fluid may flow through the check valve 291 into the actuator chamber 243.

When the actuator chamber 243 is filled with fluid, the controller 244 may close the directional control valve 239, thereby preventing fluid from escaping from the actuator chamber 243. As the cam 234 continues to rotate and the springs 228 urge the intake valves 218 towards the closed position, the actuator rod 265 will engage the end 224 of the rocker arm 226 and prevent the intake valves 218 from closing. As long as the directional control valve 239 remains in the closed position, the trapped fluid in the actuator chamber 243 will prevent the springs 228 from returning the intake valves 218 to the closed position. Thus, the fluid actuator 227 will hold the intake valves 218 in an open position, for example, at least a partially open position, independently of the action of the cam assembly 289.

When the actuator rod 265 engages the rocker arm 226 to prevent the intake valves 218 from closing, the force of the springs 228 acting through the rocker arm 226 may cause an increase in the pressure of the fluid within the fluid system 255. In response to the increased pressure, a flow of fluid will be throttled through the restricted orifice 151 into the chamber 243 of the accumulator 141 (referring to FIG. 9). The throttling of the fluid through the restricted orifice 151 will dissipate energy from the fluid within the fluid system 255.

The force of the fluid entering the accumulator 141 will act to compress the spring 149 and move the piston 147 to increase the size of the chamber 145 (referring to FIG. 9). When the pressure within the fluid system 255 decreases, the spring 149 will act on the piston 147 to force the fluid in the chamber 145 back through the restricted orifice 151. The flow of fluid through the restricted orifice 151 into the third fluid passageway 154 will also dissipate energy from the fluid system 255.

The restricted orifice 151 and the accumulator 141 will therefore dissipate energy from the fluid system 255 as fluid flows into and out of the accumulator 141 in this manner, the restricted orifice 151 and the accumulator 141 may absorb or reduce the impact of pressure fluctuations within the fluid system 255, such as may be caused by the impact of the rocker arm 226 on the actuator rod 265. By absorbing or reducing pressure fluctuations, the restricted orifice 151 and the accumulator 141 may act to inhibit or minimize oscillations in the actuator rod 265.

The controller 244 may close the intake valves 218 by opening the directional control valve 239. This allows the pressurized fluid to flow out of the actuator chamber 243. The force of the springs 228 forces the fluid from the actuator chamber 243, thereby allowing the actuator piston 237 to move within the actuator cylinder 235. This allows the rocker arm 226 to pivot so that the intake valves 218 are moved to the closed position.

The snubbing valve 133 may restrict the rate at which fluid exits the actuator chamber 243 to reduce the velocity at which the intake valves 218 are closed. This may prevent the valve elements 220 from being damaged when closing the intake ports 36.

For example, the snubbing valve 133 may control the rate at which fluid may flow into and out of actuator chamber 243. Referring to FIG. 10A, the snubbing valve 133 may be configured to initially allow a high rate of fluid flow into the actuator chamber 243 when the actuator piston 237 starts to move away from the first, home position. For example, the valving member 166 may initially be in a position such that the second end 168 of the valving member 166 is at or near the second end 165 of the cavity 163. As fluid flows from the first passageway 159 toward the actuator chamber 243, the valving member may move toward the first end 164 of the cavity, thereby initially allowing a high rate of fluid flow to the third passageway 161 and the actuator chamber 243.

Should the valving member 166 reach a position such that the first end 167 of the valving member 166 contacts the first end 164 of the cavity 163, the only available fluid flow path is through the through the passage 169. Thus, the fluid flow into the actuator chamber 243 is restricted to the lower rate of fluid flow permitted via the passage 169.

Similarly, the snubbing valve 133 may be configured to initially allow a high rate of fluid flow from the actuator chamber 243 when the actuator piston 237 starts to move toward the first, home position. For example, the valving member 166 may initially be in a position such that the first end 167 of the valving member 166 is at or near the first end 164 of the cavity 163. As fluid flows from the actuator chamber 243 toward the first passageway 159, the valving member 166 may move toward the second end 165 of the cavity, thereby initially allowing a high rate of fluid flow from the third passageway 161 and the actuator chamber 243.

Should the valving member 166 reach a position such that the second end 168 of the valving member 166 contacts the second end 165 of the cavity 163, the only available fluid flow path is through the passage 169. Thus, the fluid flow from the actuator chamber 243 is restricted to the lower rate of fluid flow permitted via the passage 169.

Referring now to FIG. 10B, the snubbing valve 133 may slow the rate at which fluid flows from the actuator chamber 243 when the actuator piston 237 approaches the home position during movement from the end position towards the home position. In this manner, the snubbing valve 133 may reduce the impact speed of the piston 237 with the piston stop 170 and the actuator cylinder 235, as well as the impact speed of the intake valve 218 with the valve seat 225 and the cylinder head.

The snubbing valve 133 may be configured to initially allow a high rate of fluid flow into the actuator chamber 243 when the actuator piston 237 starts to move away from the first, home position. For example, the valving member 348 may initially be in a position such that the second end 345 of the valving member 348 is at or near the second end 346 of the cavity 342. As fluid flows from the third passageway 161 toward the actuator chamber 243, the second fluid conduit 304 may be blocked from communication with the actuator chamber 243. Thus, fluid flows to the actuator chamber 243 via the first fluid conduit 302. The valving member 348 is moved away from the second end 346, opening the passages 347 through the valving member 348 and allowing a relatively high rate of fluid flow to the actuator chamber 243. As the actuator piston 237 is moved away from the first, home position, the second fluid conduit 304 is opened, allowing fluid communication between the third passageway 191 and the actuator chamber 243. Thus, a high rate of fluid flow from the third passageway 191 to the actuator chamber 243 is permitted.

When the actuator piston 237 starts to move toward the first, home position, the snubbing valve 133 may be configured to initially allow a high rate of fluid flow from the actuator chamber 243 through the first fluid conduit 302, via the passages 347, and through the second fluid conduit 304. For example, the valving member 348 may initially be in a position such that the first end 350 of the valving member 348 is at or near the first end 344 of the cavity 342. As fluid flows from the actuator chamber 243 toward the third passageway 161, the valving member 348 may move toward the second end 346 of the cavity 342, thereby initially allowing a high rate of fluid flow from the actuator chamber 243.

When the valving member 348 reaches a position such that the second fluid conduit 304 is blocked from communication with the actuator chamber 243, the flow rate from the actuator chamber 243 may be reduced. Should the second end 345 of the valving member 348 contact the second end 346 of the cavity 342, the only available fluid flow path is through the center one of the passages 347. Thus, the fluid flow from the actuator chamber 243 is restricted to the lower rate of fluid flow permitted via the passage 354.

An exemplary late intake closing 171 is illustrated in FIG. 12. As shown, the intake valve actuation 172 is extended into a portion of the compression stroke of the piston 212. This allows some of the air in the cylinder 112 to escape. The amount of air allowed to escape the cylinder 112 may be controlled by adjusting the crank angle at which the directional control valve 239 is opened. The directional control valve 239 may be closed at an earlier crank angle to decrease the amount of escaping air or at a later crank angle to increase the amount of escaping air. The affect of the snubbing valve 133 can be seen from the gradual taper of the late intake closing curve 171 as the compression stroke of the piston 212 approaches top dead center.

As noted previously, in certain operating conditions, it may be desired to operate the engine 110 in a conventional diesel cycle instead of the late intake Miller cycle described above. These types of operating conditions may be experienced, for example; when the engine 110 is first starting or is otherwise operating under cold conditions. The described valve actuation system 233 allows for the selective disengagement of the late intake Miller cycle.

Although some examples described herein involve late intake valve closure, it should be understood that certain examples in accordance with the invention might involve engine operation where both late and early intake valve closure is selectively provided, or engine operation where only early intake valve closure is selectively provided. For example, in some exemplary engines including a camshaft 232, the cams 234 could have an alternative profile providing cyclical early intake valve closure and the actuator 227 may be controlled to selectively delay the intake valve closing so that the delayed intake valve closing occurs before, at, and/or after bottom dead center of the intake stroke.

It should be appreciated that the snubbing valve 133 may reduce the impact velocity of the intake valve 218 and/or the actuator piston 237 regardless of whether the late/early intake Miller cycle is engaged. For example, the snubbing valve 133 may reduce the impact velocity of the intake valve 218 and/or the actuator piston 237 when the late intake Miller cycle is disabled, for example, during cold start or cold operating conditions. As long as the directional control valve 239 is opened and fluid is available to the fluid actuator 227 without a substantial return path to the tank 247, the snubbing valve 133 may operate to reduce the velocity of the intake valve 218 and/or the actuator piston 237. In such situations, the actuator rod 265 may move substantially with the rocker arm 226, thereby varying the volume of the actuator chamber 243 and allowing fluid to flow into and out of the actuator chamber 243. When the actuator chamber 243 contains fluid and the intake valve 218 is urged closed by the spring 228, the actuator piston 237 is also urged toward a home position. Thus, the volume of the actuator chamber 243 is reduced and fluid is forced out of the actuator chamber 243 as long as the directional control valve 239 is open. The snubbing valve 133 then operates as previously described to reduce the impact velocity of the intake valve 218 and/or the actuator piston 237. It should also be appreciated that the effect of the snubbing valve 133 may be beneficial during engine overspeed conditions, for example, an engine speed over about 2100 rpm.

In the exemplary embodiment of FIG. 6A, the controller 244 may disengage the late intake Miller cycle by keeping the directional control valve 239 opened. The directional control valve 239 may be opened when the controller 244 receives sensory input indicating that the engine 110 is starting or is operating under cold conditions. Opening the directional control valve 239 allows fluid to flow from the actuator chamber 243 to the tank 247 via the fluid rail 207. As long as the directional control valve 239 is not closed, the fluid actuator 227 will not prevent the intake valves 218 from returning to the closed position in response to the force of the springs 228.

Thus, when the directional control valve 239 is held open, the intake valves 218 will follow a conventional diesel cycle as governed by the cam 234. As shown in the example of FIG. 12, intake valve actuation 172 may follow a conventional closing 173. In the conventional closing 173, the closing of the intake valves 218 may substantially coincide with the end of the intake stroke of the piston 212 (or occur earlier, e.g., when the cam 234 is configured to provide early Miller cycle intake valve closure). When the intake valves 218 close at the end of the intake stroke, no air will be forced from the cylinder 112 during the compression stroke. This results in the piston 212 compressing the fuel and air mixture to a higher pressure, which will facilitate diesel fuel combustion. This may be beneficial when the engine 110 is operating in cold conditions.

In the exemplary embodiment of FIG. 6B, the controller 244 may cause late Miller cycle operation to be temporarily disabled by opening the control valve 248. The control valve 248 may be opened when the controller 244 receives sensory input indicating that the engine 110 is starting or is operating under cold conditions. Opening the control valve 248 allows fluid to flow through the restrictive orifice 257 and the fluid rail 207 to the tank 247. Opening the control valve 248 may therefore reduce the pressure of the fluid within the fluid rail 207. The decreased pressure of the fluid within the fluid rail 207 may not generate a force great enough to move the actuator piston 237. Thus, the fluid actuator 227 will not engage the intake valve 218 to prevent the intake valve 218 from closing. Accordingly, the engine 110 will operate as governed by the cam 234 (e.g., in a normal diesel cycle or in an early closing Miller cycle).

Opening the control valve 248 may also increase the responsiveness of the valve actuator 227 when the engine 110 is starting or operating under cold conditions. If the fluid within the fluid rail 207 is cold, the fluid will have an increased viscosity. The increased viscosity of the fluid may decrease the rate at which the fluid may flow into and out of the actuator chamber 243 and thereby impact the operation of the valve actuator 227. By opening the control valve 248, the cold fluid may be replaced by warmer fluid from the source of fluid 245. This may decrease the viscosity of the fluid within the fluid rail 207, which may increase the responsiveness of the valve actuator 227 when the control valve 248 is closed to operate the engine 110 on the Miller cycle.

The restrictive orifice 257 may ensure that the pressure of the fluid upstream of the restrictive orifice 257, i.e. between the source of fluid 245 and the restrictive orifice 257, does not decrease when the control valve 248 is opened. The restrictive orifice 257 may create a smaller opening than is created by the opening of the control valve 248. In other words, the opening of the control valve 248 allows fluid to flow out of the fluid rail 207 at a faster rate than the restrictive orifice 257 allows fluid to flow into the fluid rail 207. This creates a pressure drop over the restrictive orifice 257 where the pressure of the fluid on the upstream side of the restrictive orifice 257 will be greater that the pressure of the fluid in the fluid rail 207. Thus, opening the control valve 248 will not impact the pressure of fluid upstream of the restrictive orifice 257.

As will be apparent from the foregoing description, exemplary features the present disclosure may provide an engine valve actuation system that may selectively alter the timing of the intake and/or exhaust valve actuation of an internal combustion engine. The actuation of the engine valves may be based on sensed operating conditions of the engine. For example, the engine valve actuation system may implement a late intake or early intake Miller cycle when the engine is operating under normal operating conditions. The late intake or early intake Miller cycle may be disengaged when the engine is operating under adverse operating conditions, such as when the engine is cold. Thus, this might provide a flexible engine valve actuation system that provides for both enhanced cold starting capability and fuel efficiency gains.

The high pressure air provided by the exemplary air supply systems 244, 300, 400 may provide extra boost on the induction stroke of the piston 212. The high pressure may also enable the intake valve assembly 214 to be closed even later (or even earlier) than in a conventional Miller cycle engine. For example, the intake valve assembly 214 may remain open until the second half of the compression stroke of the piston 212, for example, as late as about 800 to 70° before top dead center (BTDC). While the intake valve assembly 214 is open, air may flow between the chamber 206 and the intake manifold 114. Thus, the cylinder 112 may experience less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 244, 300, 400, which may efficiently extract additional work from the exhaust energy.

Referring to the exemplary air supply system 244 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 244, and not simply more power.

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

Referring again to FIG. 16, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (CDPF) or an active diesel particulate filter (ADPF). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ, to particulate matter, i.e., soot, is within a certain range, for example, from about 20 to 1 to about 30 to 1. In some examples, an EGR system combined with the above described methods of multiple fuel injections and variable valve timing may result in a NOₓ to soot ratio of about 10 to 1. Thus, it may be desirable to periodically adjust the levels of emissions to change the NOₓ to soot ratio to a more desired range and then initiate regeneration. Examples of methods which may be used include adjusting the EGR rate and adjusting the timing of main fuel injection;

A venturi (riot shown) may be used at the EGR entrance to the fresh air inlet. The venturi would depress the pressure of the fresh air at the inlet, thus allowing EGR to flow from the exhaust to the intake side. The venturi may include a diffuser portion which would restore the fresh air to near original velocity and pressure prior to entry into compressor 144. The use of a venturi and diffuser may increase engine efficiency.

An air and fuel supply system for an internal combustion engine in accordance with the exemplary embodiments of the invention may extract additional work from the engine's exhaust. The system may also achieve fuel efficiency and reduced NOₓ emissions, while maintaining work potential and ensuring that the system reliability meets with operator expectations.

It will be apparent to those skilled in the art that various modifications and variations can be made to the subject matter disclosed herein without departing from the invention. Other embodiments of the invention will be apparent to those skilled in the art from consideration of the specification and practice of the invention disclosed herein. It is intended that the specification and examples be considered as exemplary only.

1. A method of operating an internal combustion engine including at least one cylinder and a piston slidable in the cylinder, the method comprising:
supplying pressurized air from an intake manifold to an air intake port of a combustion chamber in the cylinder; and
operating an air intake valve to open the air intake port to allow pressurized air to flow between the combustion chamber and the intake manifold substantially during a majority portion of a compression stroke of the piston,
wherein the operating includes directing fluid to a fluid actuator associated with the air intake valve.

2-55. (canceled)
